(19) United States
(12) Patent Application Publication
(10) Pub. No.: US 2017/0329064 A1
(43) Pub. Date: Nov. 16, 2017

(54) PANEL WITH INTEGRATED ILLUMINATION

(71) Applicants: SAINT-GOBAIN ADFORS, Courbevoie (FR); ABV S.A., Seraing (BE)

(72) Inventors: Eric DOR, Heron (BE); Jean-Marie BRICTEUX, Dalhem (BE); Sebastien LE ROY, Houilles (FR); Jean-Yves LALUET, Paris (FR)

(73) Assignees: SAINT-GOBAIN ADFORS, Courbevoie (FR); ABV S.A., Seraing (BE)

(21) Appl. No.: 15/520,110

(22) PCT Filed: Sep. 21, 2015
(86) PCT No.: PCT/EP2015/071615

§ 371 Date: Apr. 19, 2017

(30) Foreign Application Priority Data
Oct. 21, 2014 (EP) 14189816.3

(51) Int. Cl. F21V 8/00; G10K 11/168; F21V 33/00; F21W 131/402; F21Y 2115/10; F21Y 105/00; F21W 131/301

(52) U.S. Cl. CPC G02B 6/001; F21V 33/0012; G10K 11/168; F21W 2131/301; F21Y 2115/10; F21Y 2105/00; F21W 2131/402

(57) ABSTRACT

An illuminating panel includes a support holding an integrated illumination. The integrated illumination is an illuminating textile including woven optical fibers coupled to light sources. The optical fibers emit light under an angle suitable for enlightening an adjacent surface substantially perpendicular to the plane of the illuminating panel.

### FIELD OF THE INVENTION

The present invention relates to an illuminating panel comprising a support structure holding an integrated illumination for enlightening an adjacent surface substantially perpendicular to the plane of the illuminating panel, such as a worktop or a desk.

### BACKGROUND OF THE INVENTION

In open space offices or work places, partition panels are often used. These partition panels provide some visual privacy and may also function as acoustic absorber between the desks or worktops.

In order to enlighten the individual desks or worktops, usually a standalone lamp is installed or a lamp fitting is mounted on top of the desk partition.

A general problem is that in case of a standalone lamp the light is usually a point source, and that, even in case of an extended lamp on top of the worktop partition, the light is not uniformly dispersed over the surface of the worktop.

Another problem is that a standalone lamp takes space on the desk or worktop.

In an attempt to solve the above problem, WO 2013/050908 provide a desk partition panel comprising a metallic sheet perforated with holes with an integrated lighting unit comprising a light guide material. The light guide comprises a sheet of PMMA in the example, but other light guiding materials can be used such as polycarbonate (PC), cyclo-olefin copolymer (COC) or a double layer prism foil. The integrated unit also comprises a line of LEDs for coupling light into one or more edges of the sheet of light guide material. The sheet of light guide material comprises an array of light output apertures forming an array of low intensity light sources. These apertures have a specific shape resulting in light confined to the desk area.

However, a drawback of using a light guide is that, in case a higher light intensity is required, more low intensity light sources, thus more apertures have to be provided in the sheet which is obviously subject to limitations.

In addition, though a light guide provides more uniform light on the worktop compared to a standalone lamp, still lower and higher light intensity patterns remains as a function of the position of the apertures and if increased light uniformity is aimed for, the number of apertures has to be increased.

Another drawback is that, in terms of acoustic properties, such light guide is an extra structure decreasing the acoustic absorbance of an acoustical absorber layer behind it. The reason is that a light guide comprises a reflector, placed behind the light guide, for reflecting light either back into the light guide or through the holes towards the viewer. Though this reflector may be made micro-perforated as mentioned in WO 2013/050908 to improve the acoustic absorption of the light guide described herein versus conventional light guides, the capabilities of the acoustical absorber layer in the panel will be reduced.

Considering the above, it is an object of the present invention to provide an illuminating panel for illuminating a worktop or desk not suffering from limitations with regards to the number of apertures and providing improved uniformity.

The application WO 2004/068203 discloses a rear projection type screen comprising an optical fiber sheet comprising warp and weft optical fibers embedded in a coating. The embedded optical fiber sheet is grinded on both sides in order to expose top portion of protrusions of the optical fibers at intersections of the warp and weft optical fibers. As a result, light passing through the optical fibers can emit from the ground portions. Insofar as this device is a rear projection type screen, rays of light are projected from a projector at the back surface of the display screen. These rays of light incident on the ground portions of the optical fiber present at the back surface of the display screen can propagate in the optical fibers and reach the ground portions of the optical fiber at the front surface of the display screen. Therefore, light can emit from the front surface of the display screen.

According to WO 2004/068203, the viewing angle of the screen measured at a distance of 8 meter is between 60 to 63° C. (see table 3 of this application). A viewing angle is defined to be an angle between the center of the optical fiber sheet and a position at which brightness is half of that of the center.

However, in the case of an illuminating panel for worktop or desk, even if the panel emits light in all direction, it is advantageous that the maximum of intensity correspond to a certain angle notably a peak between 20 to 40 degrees in regard to the plane of the panel in the direction of the surface to be illuminated.

Therefore, the display screen disclosed in WO 2004/068203 is not suitable to illuminate a worktop or desk. In fact, the device does not enable to illuminate a surface in the immediate vicinity of the screen and a fortiori with a maximum intensity at an angle between 20 to 40 degrees with respect to the plane of the panel in the direction of the surface to be illuminated.

It is an object of the present invention to provide an illuminating panel particularly suitable to illuminate a worktop or desk.

It is also an object of the present invention to provide an illuminating panel for illuminating a worktop or desk, which simultaneously illuminates the desk and provides excellent back light against a computer screen.

Another object of the present invention is to provide an illumination panel for illuminating a worktop or desk with improved acoustical absorption characteristics.

In addition, another object of the present invention is to provide an illumination panel for illuminating a worktop or desk aiming to have a relaxing or even therapeutic effect on the viewer.

### SUMMARY OF THE INVENTION

The present invention is directed to an illuminating panel comprising a support structure holding an illuminating textile, said illuminating textile comprising woven optical fibers coupled to a number of light sources, wherein the optical fibers diffuse light under an angle suitable for enlightening an adjacent surface substantially perpendicular to the plane of the illuminating panel.

In particular, the invention concerns an illuminating panel comprising a support structure holding an illuminating textile, said illuminating textile comprising woven optical fibers coupled to a number of light sources and capable of diffusing light laterally along their longitudinal axis, wherein:

the illuminating textile is mounted in the illuminating panel so that:
the plane of the illuminating textile is oriented substantially perpendicularly to an adjacent surface intended to be enlightened,
at least part of the optical fibers is connected to light sources and is oriented so that their longitudinal axis be substantially perpendicular to an adjacent surface intended to be enlightened,

light is injected at free ends of these optical fibers so that the propagation of the light along the longitudinal axis of these optical fibers is directed towards and/or opposite to the plane to be enlightened.

The illuminating panel comprises two main faces. The illuminating textile forms part of at least one face of the illuminating panel.

The light sources are preferably light emitting diode (LED) sources.

### BRIEF DESCRIPTION OF THE DRAWINGS

FIG. 1 illustrates a first embodiment in accordance with the present invention.

FIG. 2 illustrates a second embodiment in accordance with the present invention.

### DESCRIPTION OF THE INVENTION

In a first embodiment in accordance with the present invention an illuminating panel is provided comprising a support structure holding an illuminating textile, said illuminating textile comprising woven optical fibers coupled to an number of light sources, wherein the optical fibers diffuse light under an angle suitable for enlightening an adjacent surface substantially perpendicular to the plane of the illuminating panel.

According to the invention, an “illuminating textile”, also known as illuminating fabric, is a sheet obtained by weaving of yarns directionally distributed comprising optical fibers and eventually binding yarns. Weaving is the result of interlacing, in a same plane, yarns positioned in the direction of the warp (referred to hereinbelow as warp yarns) and yarns positioned perpendicular to the warp yarns, in the direction of the weft (referred to hereinbelow as weft yarns). Such illuminating textile comprising warp- and/or weft-woven optical fibers are for example described in US 2009291606 and US 2006144460, herewith incorporated by reference.

Once connected to a light source, the optical fibers are capable of emitting light sideways owing to the presence of invasive alterations along their surface. Therefore, the optical fibers diffuse light laterally along their longitudinal axis

The binding yarns make it possible to ensure the good cohesion of the whole of the illuminating textile and to impart, as a function of their nature, their dimension and/or their mechanical properties, particular properties.

The optical fibers extend outside of the surface defined by the illuminating textile corresponding to an edge of the illuminating textile. The part of the optical fibers which extend outside is called the individual optical fibers, the ends of the optical fibers or the free ends of the optical fibers.

According to the invention, the feature “optical fibers coupled or connected to light sources” means that the free ends of the optical fibers are connected to a light source.

The illuminating textile is mounted in the illuminating panel so that:
the plane of the illuminating textile is oriented substantially perpendicularly to an adjacent surface intended to be enlightened,
at least part of the optical fibers comprising free ends is connected to light sources and is oriented so that their longitudinal axis be substantially perpendicular to an adjacent surface intended to be enlightened.

The optical fibers make it possible both to convey the light inside their structure along their longitudinal axis but also to emit the light sideways. Consequently, the optical fibers make it possible to guide the light inside the illuminating textile in a distributed manner and to diffusely illuminate the main surface of the illuminating textile. A part of the light injected at the free ends of the optical fibers is propagated all along the fiber and a part is scattered laterally by the invasive alterations.

An illuminating textile in the context of the present invention is capable of diffusing light laterally but preferentially under an angle, this angle being suitable for enlightening an adjacent surface substantially perpendicular to the plane of the illuminating panel such as a worktop or desk.

The applicant discovered that if the light is injected so that the propagation direction of the light along the longitudinal axis of the optical fibers is directed towards the plane to be enlightened, i.e. the light enters by the top side of the illuminating textile mounted in the illuminating panel, the light is diffused by the invasive alterations with an angle particularly appropriate for enlightening a horizontal surface such as a worktop or desk. In fact, the illuminating textile emits light in all direction but the maximum of intensity correspond to a certain angle. The light is extracted from the optical fibers with an extraction profile that shows a peak between 20 and 40, preferably 25 and 35 degrees with respect to the light propagation direction corresponding to the plane of the illuminating panel (and the plane of the illuminating textile). An angle of about 30 degrees in view of the plane of the illuminating panel is known to be appropriate for enlightening a horizontal surface in immediate vicinity such as a worktop or desk, so that a person sitting and working in front of it is not bothered by his own shadow on the worktop or desk.

The optical fibers diffuse light preferentially under an angle between 15 and 45 or between 20 and 40, preferably between 25 and 35, and even better between 25 and 30 degrees, in view of the plane of the illuminating panel. That means the light is extracted from the optical fibers with an extraction profile that shows a peak between 20 and 40 degrees, preferably 25 and 35 degrees and even better between 25 and 30 degrees with respect to the light propagation direction corresponding to the plane of the illuminating textile or to the plane of the illuminating panel.

The illuminating textile may emit light preferentially under an angle between 15 and 45 or between 20 and 40, preferably between 25 and 35, and even better between 25 and 30 degrees in view of the plane of the illuminating panel.

According to this embodiment, the light sources connected to at least part of the optical fibers oriented so that their longitudinal axis be substantially perpendicular to an adjacent surface intended to be enlightened are mounted in the illuminating panel so that the propagation of the light along the longitudinal axis of these optical fibers is directed towards to the plane to be enlightened. The light sources are selected from white LED sources.

In this way, the surface of the plane to be enlightened, such as a desk or a worktop, is advantageously enlightened with a white light preferably according to an angle of about 30 degrees in view of the plane of the illuminating panel.

The applicant also discovered that if the light is injected so that the propagation direction of the light along the longitudinal axis of the optical fibers is directed at the opposite of the plane to be enlightened, i.e. the light enter by the bottom side of the illuminating textile mounted in the illuminating panel, the light is diffused by the invasive alterations with an angle particularly appropriate for enlightening the face of a person working on horizontal surface such as a worktop or desk.

According to this embodiment, the light source connected to at least part of the optical fibers oriented so that their longitudinal axis be substantially perpendicular to an adjacent surface intended to be enlightened are mounted in the illuminating panel so that the propagation of the light along the longitudinal axis of these optical fibers is directed opposite to the plane to be enlightened. The light sources are selected from blue LED sources.

In this way, the face of a person sitting facing the illuminating panel is advantageously enlightened with a blue light known to have a relaxing or even therapeutic effect.

Therefore, the applicant discovered that the injection of light carried out so that the propagation direction of the light along the longitudinal axis of the optical fibers is towards and/or opposite to the plane to be enlightened presents advantageous effects.

According to an embodiment, the illuminating panel comprises at least two types of light sources selected from LED having a different color, each type of light source being connected to free ends of optical fibers oriented so that their longitudinal axis be substantially perpendicular to an adjacent surface intended to be enlightened. One type of light source injects light at free ends of optical fibers so that the propagation of the light along the longitudinal axis of these optical fibers is directed towards and another type of light source injects light at free ends of optical fibers so that the propagation of the light along the longitudinal axis of these optical fibers is directed opposite to the plane to be enlightened.

The light emitted from a LED has a specific wavelength and thus a specific color. It is the LED's semiconductor material which determines the dominant wavelength and thus the emitting light's color. According to the invention, LEDs having a different color means that the LEDs are able to emit a different light corresponding to a specific spectral distribution of wavelength.

The optical fibers comprise free ends capable of being connected to light source in order to transmit the light and emit the light sideways at the alterations. The free ends of the optical fibers may be braided or assembled in the form of bundles so as to unite a variety of free ends opposite a same light source, preferably at the edge of the illuminating textile.

The illuminating textile comprises one or more point light sources oriented opposite at least one free end of an optical fiber, preferably at the edge of the illuminating textile. Alternatively, the illuminating textile may comprise an extended light source oriented opposite a plurality of free ends of optical fibers. This or these light sources are connected to the optical fibers. The optical fiber(s), preferably the free end(s) of the optical fibers, optionally cut or braided, are connected to the light sources.

The light sources intended to light the free ends of the optical fibers may be of different natures, and in particular be in the form of light emitting diodes or of extended sources such as incandescent lamps, fluorescent tubes or discharge tubes incorporating a gas such as neon. The light sources are advantageously light emitting diodes.

Advantageously, an optical lens may be inserted between the source and the ends of the optical fibers in order to concentrate the light on said ends and limit the light transmission losses. The light sources used in embodiments in accordance with the present invention may be any light sources suitable for coupling optical fibers to (optionally via lenses), but preferably LED sources. At least part of the optical fibers may be coupled to LED.

LED sources used in illuminating panels in accordance with the present invention may all suitable types available, e.g. white LEDs, blue LEDS or RGB (Red Green Blue) LEDs depending on the effect to be achieved. Illuminating textiles with white LED sources may obviously be used to enlighten a surface to be enlightened while illuminating textiles with blue LED sources may be used for spreading blue light in the environment or even in the eyes of a viewer sitting or working in front of an illuminating panel in order to provide a relaxing and/or therapeutic effect. Combinations thereof are also possible.

LED sources may be, and usually are, accompanied by dedicated lenses for coupling light into the optical fibers.

The optical fibers comprise invasive alterations, corresponding to notches or small slits, which enable the extraction of light at the fibers since they modify the angle of reflection of the light rays inside the fiber and the lateral transmission of light outside of the fiber. Light can be decoupled laterally from optical fibers by using different treatments. A possibility to achieve lateral emission is to intentionally disturb the core-cladding boundary layer through mechanical or chemical damage such as sandblasting or laser abrasion, i.e. cutting grooves into the sides of the optical fiber.

The combination of treating optical fibers such that the cladding of the optical fiber is sufficiently damaged along the longitudinal axis makes that optical fibers treated as such and connected to light sources such as LEDs emit light laterally in view of its longitudinal axis.

The surface of the optical fibers woven in the illuminating textile is treated to diffuse light laterally in view of the longitudinal axis of the fibers, at least in certain portions thereof. The surface treatment of the fibers may be performed after they have been woven. Preferably, the luminous sections of the optical fibers, i.e. the portions where the cladding is treated to allow lateral diffusion of light, are located on the outer side of the illuminating textile.

The propagation direction of light in an optical fiber when injected is first to follow the direction of the core of the optical fiber constituting a wave. If defects are generated along the optical fiber, leakage of light is induced. The repartition of a high amount of small leakages along the optical fiber generates high lateral diffusion up to 90 percent, and preferentially showing a diffusion profile with a peak between 20 and 40 degrees, preferably between 25 and 35 degrees, and even better between 25 and 30 degrees with respect to the longitudinal axis of the fiber.

The illuminating panel in accordance with the present invention may be used for replacing a standalone lamp on a desk or for replacing an assembly of LEDs coupled to a light guide as discussed above, which helps to save space on the desk.

Another benefit of the present invention is that an illumination panel in accordance with the present invention makes use of the full surface of the illuminating textile and does not suffer from limitations with regards to the number of apertures as is the case with a light guide.

In addition, using an illuminating textile may improve the uniformity of the light incident on the surface to be enlightened.

Another benefit is that an illuminating panel according to the present invention may simultaneously illuminate the desk and provide excellent back light against a computer screen.

Whatever the position and the direction of emission of the light sources coupled to the optical fibers are, the optical fiber can be bent in such a way that upon entering the illuminating textile, the optical fibers are oriented in the right position to enlighten the target surface. In an embodiment in accordance with the present invention the optical fibers are bent at least over 90 degrees, or at least over 120 degrees, and more preferred at least over 150 degrees, and preferably over about 180 degrees between the LED source and entering the illuminating textile.

As explained above, if different types of light sources are used such as LED with different colors, they can be mounted in the illuminating panel such that they emit light in opposite direction with respect to each other in order not to interfere each other in coupling light into the optical fibers (see example).

According to the invention, at least part of the optical fibers is oriented such that within the illuminating textile the longitudinal axis of the optical fibers is substantially perpendicular to the surface to be enlightened, i.e. if the surface to be enlightened is horizontal, then the optical fibers are positioned vertically with respect to its longitudinal axes. It is understood that, in case the illuminating panel is mounted for example horizontally such that the optical fibers are positioned horizontally with respect to its longitudinal axes, then a surface placed vertically can be enlightened.

In a particular embodiment in accordance with the present invention, an illuminating panel is provided, wherein the surface to be enlightened is a worktop or desk, and wherein at least part of the optical fibers is oriented such that within the illuminating textile the propagation direction of the light within the optical fibers is directed towards the worktop or desk. Preferably, at least part of the optical fibers are coupled to white LED sources and oriented such that within the illuminating textile the propagation direction of the white light within the optical fibers is directed towards the surface to be enlightened.

In case of a desk to be enlightened, the propagation direction of the light within the illuminating textile is top-down towards the desk such that light laterally leaving the optical fibers is incident on the worktop or desk.

In an embodiment according to the present invention illuminating panel may be provided wherein at least part of the optical fibers are coupled to blue LED sources and oriented such that within the illuminating textile the propagation direction of the blue light within the optical fibers is directed not towards a surface to be enlightened but towards a viewer sitting or working in front of the panel. For example, in case of a worktop or desk, the optical fibers are oriented vertically with respect to its longitudinal axis and within the illuminating textile the propagation direction of the light is bottom-up such that blue light laterally leaving the optical fibers is directed towards the viewer's eyes. Such embodiment is advantageous for example for providing a relaxing environment to a person working at a worktop or desk.

In a particular embodiment in accordance with the invention, part of the optical fibers are coupled to white LED sources and part of the optical fibers are coupled to blue LED sources, and wherein the optical fibers are oriented such that within the illuminating textile the propagation direction of the blue light is directed opposite to the white light and opposite to the surface to be enlightened. This embodiment is particularly advantageous because it can be used for enlightening a worktop or desk with white light while blue light directed to the person working in front of it provides a relaxing and/or therapeutic effect.

Therefore, at least part of the optical fibers may be coupled to blue LED sources and oriented such that within the illuminating textile the propagation direction of the blue light within the optical fibers is directed opposite to the surface to be enlightened.

The support structure for holding the illuminating textile may be made of any material rigid enough for holding the illuminating textile and a panel constituting the illuminating panel. However, in view of the fact that LED sources have to be cooled, it is advantageous if the support comprises a frame or panel at least partially made of heat conducting material (e.g. aluminum) for cooling the LED sources and wherein the LED sources are fixed onto the heat conducting part of the frame or panel. Therefore, the support structure can comprise a frame or panel made of heat conducting material and wherein the LED sources are fixed onto said frame or panel.

In an embodiment according to the present invention the illuminating panel comprises at least an acoustic absorbing layer. The illuminating textile is acoustically transparent. The illuminating textile can covers such acoustic absorbing layer.

The acoustic absorbing layer corresponds to a sound absorbing layer. The illuminating textile is “acoustically transparent” meaning that sound at least partially passes the illuminating textile. The sound is not reflected by the luminous textile while it would be in the case of many materials including a metal plate. After passing the illuminating textile, the sound is then absorbed by the sound absorbing layer covered by the illuminating textile. An illuminating panel of this embodiment has not only an enlightening function but serves also as acoustic panel, which may be very important in open space offices wherein the different workplaces are preferably individually enlightened and enjoying improved acoustical isolation.

In a particular embodiment an illuminating panel is provided comprising a frame holding a wooden panel in between two acoustic absorbing layers, and wherein LED sources are fixed onto the frame in between the acoustic absorbing layers.

The acoustic absorbing layer may be made of any material suitable for absorbing sound and in particular a technical foam.

Illuminating panels according to the present invention may be adapted for being mounted onto a worktop or desk, or for being mounted on a floor for dividing a number of workplaces. It is obvious that these panels may also be used as a wall, floor, or ceiling element enlightening any adjacent surface substantially perpendicular to the plane of the illuminating panel.

It is also an object of the present invention to provide an illuminating panel for illuminating a worktop or desk, which simultaneously illuminates the desk and provides excellent back light against a computer screen.

Another object of the present invention is to provide an illumination panel for illuminating a worktop or desk with improved acoustical absorption characteristics.

In addition, another object of the present invention is to provide an illumination panel for illuminating a worktop or desk aiming to have a relaxing or even therapeutic effect on the viewer.

The invention also concerns a desk partition comprising an illuminating panel according to the invention wherein the surface intended to be enlightened is defined by a desk to define separate desk areas.

The invention also concerns the use of an illuminating panel as a desk partition adapted for being mounted onto a worktop or desk, or for being mounted on a floor for dividing a number of workplaces. The panel is intended to enlighten a desk comprising a surface which is adjacent and substantially perpendicular to the plane of the illuminating panel.

The invention also concerns office furniture comprising an illuminating panel and a worktop or a desk comprising a surface which is adjacent and substantially perpendicular to the plane of the illuminating panel. The surface intended to be enlightened is a desk or a worktop divided in separate workspace.

### EXAMPLE

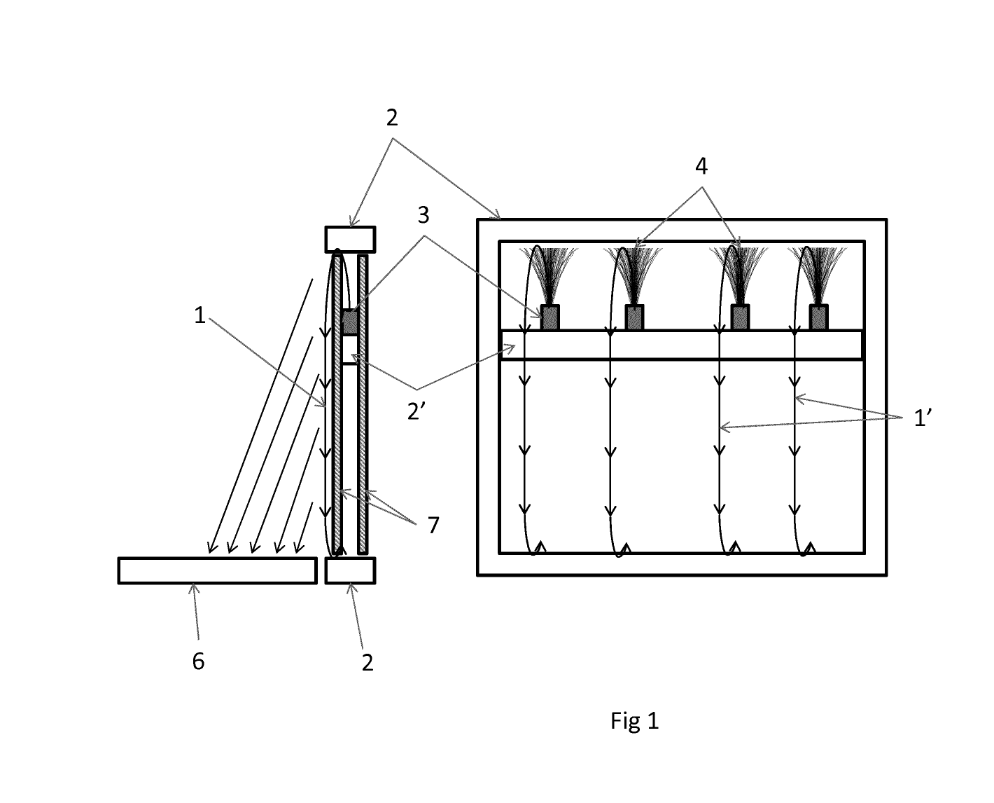

FIG. 1 illustrates an example of a “single injection” illuminating panel for illuminating a desk, i.e. an illuminating panel wherein one type of LED sources is used for injecting light into the optical fibers.

An illuminating textile 1 comprising optical fibers woven with fiberglass is hold by a support structure 2 such as an aluminum frame. The illuminating textile is oriented substantially perpendicularly to an adjacent surface intended to be enlightened 6. The illuminating textile 1 covers an acoustic absorbing layer 7.

At least part of the optical fibers is connected to light sources and is oriented so that their longitudinal axis be substantially perpendicular to the adjacent surface intended to be enlightened 6. The longitudinal axis of these the optical fiber's is vertically oriented.

The light is injected at free ends of these optical fibers so that the propagation of the light along the longitudinal axis of these optical fibers is directed towards to the plane to be enlightened 6. The propagation direction of the light is top-down (1′) towards the desk 6.

The individual optical fibers or free ends of the optical fibers of the illuminating textile are collected in a plurality of bundles 4, each bundle coupled to a light source 3, preferably white LED source, and accompanying dedicated lens.

The light sources 3, preferably white LED sources, are mounted between acoustic absorbing layers 7 on an aluminum cross member 2′ of the frame for cooling the LED sources. The optical fibers are connected to the light sources, preferably white LED.

The optical fibers are bent over substantially 180 degrees between the LED source and the illuminating textile.

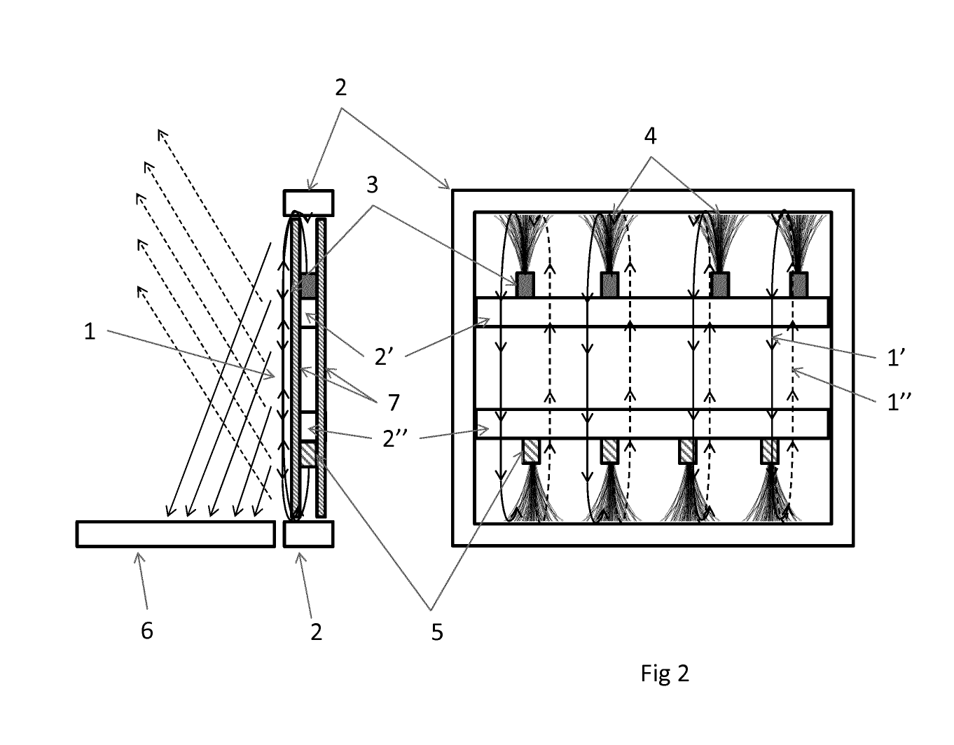

Further, FIG. 2 illustrates an example of a “double injection” illuminating panel for illuminating a desk, i.e. an illuminating panel wherein two types of LED sources (3, 5) are used for injecting light into the optical fibers in opposite direction.

The light is injected at free ends of these optical fibers so that the propagation of the light along the longitudinal axis of these optical fibers is directed towards and opposite to the plane to be enlightened 6.

The optical fibers are connected to the two types of light sources 3, preferably the white LED sources and to the blue LED sources.

One type of light sources 3, preferably white LED sources 3 are mounted on a first aluminum cross member (2′) of the frame. Another type of light sources 5, preferably blue LED sources are mounted on a second cross member (2″) below the first cross member.

Within the illuminating textile, the propagation direction of light emitted by one type of light sources, preferably the white light is top-down (1′) towards the desk and the propagation direction of light emitted by another type of light sources, preferably the blue light is bottom-up (1″) towards the ceiling.

The blue light may be provided with a calibrated frequency straight to the user's eyes, with a pre-determined intensity, typically of about 180 lux. The purpose of having blue LED sources is to create wellness by lowering “winter/light breakdown” effects. White light is transported top-down to illuminate the desk (solid arrows) and due the extraction angle of 30 degrees incident on the desk (6), while blue light is transported bottom-up and due to the opposite extraction angle of about 30 degrees directing into the eyes of person working at the desk (dashed arrows).

In the above examples, the optical fibers are bent over substantially 180 degrees between the LED source and entering the illuminating textile. Also injection of the light in the continuity of the plane of the illuminating textile is a possibility. The directionality of light and the extraction angle of light along the optical fiber axis would be exactly the same.

1. An illuminating panel comprising:
a support structure holding an illuminating textile, said illuminating textile comprising woven optical fibers coupled to a number of light sources capable of diffusing light laterally along their longitudinal axis, wherein:
the illuminating textile is mounted in the illuminating panel so that:
a plane of the illuminating textile is oriented substantially perpendicularly to an adjacent surface intended to be enlightened, and
at least part of the optical fibers is connected to light sources and is oriented so that a longitudinal axis of the optical fibers is substantially perpendicular to an adjacent surface intended to be enlightened,
light is injected at free ends of the optical fibers so that propagation of the light along the longitudinal axis of the optical fibers is directed towards and/or opposite to a plane to be enlightened.

2. The illuminating panel according to claim 1, wherein the optical fibers diffuse light preferentially under an angle between 20 and 40 degrees in view of a plane of the illuminating panel.

3. The illuminating panel according to claim 1. wherein the light sources connected to at least part of the optical fibers oriented so that the longitudinal axis is substantially perpendicularly to the adjacent surface intended to be enlightened and mounted in the illuminating panel so that the propagation of the light along the longitudinal axis of these the optical fibers is directed towards to the plane to be enlightened are selected from white LED sources.

4. The illuminating panel according to claim 1, wherein at least part of the optical fibers are coupled to white LED sources and oriented such that within the illuminating textile the propagation direction of white light within the optical fibers is directed towards the surface to be enlightened.

5. The illuminating panel according to claim 1, wherein the light source connected to at least part of the optical fibers oriented so that the longitudinal axis is substantially perpendicularly to an adjacent surface intended to be enlightened and mounted in the illuminating panel so that the propagation of the light along the longitudinal axis of these optical fibers is directed opposite to the plane to be enlightened are selected from blue LED sources.

6. The illuminating panel according to claim 1, wherein at least part of the optical fibers are coupled to blue LED sources and oriented such that within the illuminating textile the propagation direction of blue light within the optical fibers is directed opposite to the surface to be enlightened.

7. The illuminating panel according claim 1, further comprising at least two types of light source selected from LED having a different color, each type of light source being connected to free ends of the optical fibers oriented so that the longitudinal axis is substantially perpendicular to the adjacent surface intended to be enlightened.

8. The illuminating panel according to claim 7, wherein one type of the at least two types of light source injects light at free ends of the optical fibers so that the propagation of the light along the longitudinal axis of the optical fibers is directed towards the plane to be enlightened and another type of the at least two types of light source injects light at free ends of the optical fibers so that the propagation of the light along the longitudinal axis of the optical fibers is directed opposite to the plane to be enlightened.

9. The illuminating panel according to claim 1, wherein the support structure comprises a frame or panel made of heat conducting material and wherein the light sources include LED sources are fixed onto said frame or panel.

10. The illuminating panel according to claim 1, further comprising at least an acoustic absorbing layer.

11. The illuminating panel according to claim 1, wherein the illuminating textile is acoustically transparent and wherein the illuminating textile covers an acoustic absorbing layer.

12. The illuminating panel according claim 1, further comprising a frame holding a wooden panel in between two acoustic absorbing layers, and wherein LED sources are fixed onto the frame in between the said acoustic absorbing layers.

13. The illuminating panel according to claim 1, wherein the illuminating panel is a partition panel adapted for being mounted onto a worktop or desk, or for being mounted on a floor for dividing a number of workplaces.

14. Office furniture comprising:
the illuminating panel according to claim 1; and
a worktop or a desk comprising a surface which is adjacent and substantially perpendicular to a plane of the illuminating panel.

15. The office furniture according to claim 14, wherein the surface intended to be enlightened is a desk divided in a separate workspace.

16. The illuminating panel according to claim 2, wherein the angle is between 25 and 35 degrees in view of the plane of the illuminating panel.

17. The illuminating panel according to claim 2, wherein the angle is between 25 and 30 degrees in view of the plane of the illuminating panel.
